(19) United States
(12) Patent Application Publication
(10) Pub. No.: US 2006/0214930 A1
(43) Pub. Date: Sep. 28, 2006

(54) Image processing method and computer readable medium

(75) Inventor: Kazuhiko Matsumoto, Minato-ku (JP)

Correspondence Address: PEARNE & GORDON LLP, 1801 EAST 9TH STREET, SUITE 1200, CLEVELAND, OH, 44114-3108, US

(73) Assignee: ZIOSOFT, INC., Tokyo (JP)

(21) Appl. No.: 11/321,231

(22) Filed: Dec. 29, 2005

(30) Foreign Application Priority Data
Mar. 23, 2005 (JP) 2005-084120

(51) Int. Cl. G06T 17/00

(52) U.S. Cl. 345/424

(57) ABSTRACT

A rendering method such as a maximum value method or an average value method is determined for volume data containing a region having a thickness of an observation object, and an arbitrary surface, which is a surface to be displayed, is generated. Next, a rendering region corresponding to the arbitrary surface is generated. A position (for example, x-y coordinate) on the arbitrary surface corresponding to each pixel in the rendering region is obtained. Next, the thickness d at the position (x, y) on the arbitrary surface is calculated. An image is generated according to the thickness information for each pixel in the rendering region.

This application claims foreign priority based on Japanese Patent application No. 2005-084120, filed Mar. 23, 2005, the contents of which is incorporated herein by reference in its entirety.

### BACKGROUND OF THE INVENTION

1. Field of the Invention

This invention relates to an image processing method and a computer readable medium for image processing, for generating display data corresponding to each point on an arbitrary plane cut out from volume data.

2. Description of the Related Art

A revolution is brought about in the medical field with the advent of CT (Computed Tomography) and MRI (Magnetic Resonance Imaging) making it possible to directly observe an internal structure of a human body, by the progress in the image processing technology using a computer. Medical diagnosis using tomographic images of a living body is widely conducted. Further, in recent years, as a technology for visualizing a complicated three-dimensional structure of the inside of a human body which is hard to understand simply from the tomographic images of the human body, for example, volume rendering has been used for medical diagnosis. In volume rendering, an image of the three-dimensional structure is directly drawn from three-dimensional digital data of an object provided by CT.

As three-dimensional image processing in volume rendering, Raycast, MIP (Maximum Intensity Projection), MinIP (Minimum Intensity Projection), MPR (Multi Planar Reconstruction) and CPR (Curved Planar Reconstruction) are generally used, and further, 2D sliced images, etc., are generally used as two-dimensional image processing.

FIGS. 16A and 16B are explanatory diagrams showing the case when an arbitrary cross-section is cut out from volume data by MPR (Multi Planar Reconstruction) for display. By MPR, as shown in FIG. 16A, an arbitrary cross-section 11 can be cut out from volume data 51, and the cross-section can be displayed. FIG. 16B is a display image of an internal tissue of a human body by MPR.

FIGS. 17A and 17B show an example of displaying a cross-sectional curved surface along an arbitrary shape of a volume by CPR (Curved MPR). In CPR, as shown in FIG. 17A, internal arbitrary cross-sectional curved surfaces 52, 53, 54, 55 and 56 of the volume data 51 can be set, and a cross-sectional image thereof can be displayed. FIG. 17B shows a path 57 set along a human body tissue to be observed. In CPR, for example, the path 57 can be set along a center line of a vessel, and a CPR image generated along the path 57 can be displayed. Since a curved surface can be thus displayed in the CPR image, CPR is suited for displaying a winding organ such as a vessel.

FIG. 18A shows an MPR image cut out on a plane (thickness 0), and FIG. 18B shows an MIP image cut out on a plane having some thickness. As shown in FIG. 18A, in the MPR image cut out on the plane (thickness 0), each pixel on the image references a voxel value of only one point on the plane. Thus, there are disadvantages such that a noise such as a contrast medium 61 easily appears, and a meandering tissue such as a vessel 62 is hard to observe.

On the other hand, in a MIP image cut out on the plane having some thickness as shown in FIG. 18B, a region having some thickness is cut out and MIP processing is performed. Thus, each pixel on the image references and combines a plurality of voxel values in the region. Therefore, a noise such as a contrast medium 63 can be reduced, and a meandering tissue such as a vessel 64 is also easily observed. A MIP image having thickness of 0 is the same as an MPR image having thickness of 0 because the maximum value is obtained only at one point. In an MPR image having thickness larger than 0, an average value of data within the range of the thickness is used; in a MIP image having thickness larger than 0, the maximum value of data within the range of the thickness is used.

There are related arts which provide an image associated with a plane having a uniform thickness: an example of extracting and deforming a volume to be a planar shape having some thickness so that surface data is easily observed (for example, refer to US Published Application 2004-0161144); and an example of setting a region having a certain thickness on the basis of the surface of an object, and calculating MIP in the region (for example, refer to “Soap-Bubble,” visualization and quantitative analysis of 3D coronary magnetic resonance angiograms, Philips Medical Systems, etc., Magnetic Resonance in Medicine, Volume 48, Issue 4, Pages 658-666, Published Online: 26 Sep. 2002).

Thus, in an MPR image having some thickness or a CPR image having some thickness in the related arts, the thickness of the cross-section to be cut out is constant for the entire region. However, a thickness appropriate for displaying the image depends on a tissue and an observation object.

For example as described above, the cross-section to be cut out needs a certain thickness to reduce noise. However, when observing a tissue that can be photographed clearly in detail, if the thickness is too large, the details are not reflected on the display image.

### SUMMARY OF THE INVENTION

An object of the invention is to provide an image processing method and a computer readable medium for image processing capable of reducing noise and displaying fine details of a tissue clearly.

An image processing method of the invention is an image processing method for generating display data using a volume rendering method, said image processing method comprising: generating a surface; determining a thickness corresponding to each point on the generated surface based on at least one voxel value corresponding to said each point on the generated surface; and generating the display data corresponding to said each point on the generated surface, based on at least one voxel value corresponding to the determined thickness.

According to the image processing method of the invention, the thickness suited for the observation object is determined, and the display data corresponding to each point on the generated surface is generated from a plurality of voxel values corresponding to the thickness. Thus, noise can be reduced and the fine details of the tissue can also be displayed clearly.

In the image processing method of the invention, the display data is calculated by at least any one of a raysum method, an average value method and a ray casting method. In the image processing method of the invention, the display data is calculated by an MIP (Maximum Intensity Projection) method or a MinIP (Minimum Intensity Projection) method.

In the image processing method of the invention, the thickness is determined based on the voxel value of at least one point in the proximity of said each point on the generated surface. In the image processing method of the invention, the thickness is changed dynamically.

According to the image processing method of the invention, the thickness is determined based on information on the neighborhood tissue of an observation point, so that S/N can be improved and the fine details of the tissue can also be displayed clearly. The user changes parameters for dynamically changing the thickness corresponding to each point on the generated surface, whereby the observation object can be displayed clearly.

In the image processing method of the invention, the thickness is determined with reference to an LUT (look-up table) indicating relations between the voxel value and the thickness.

According to the image processing method of the invention, the thickness suited for the tissue of the observation object can be set with the LUT, and the optimum thickness can be automatically determined for every portion on the cross-sectional surface to be cut out. Thus, noise can be reduced and the fine details of the tissue can also be displayed clearly.

In the image processing method of the invention, the thickness is determined with reference to external data corresponding to said each point on the generated surface.

According to the image processing method of the invention, with reference to the value of the data acquired from an external apparatus such as a PET apparatus, for example, the thickness d is made small in a portion where the active mass of the tissue is large because the portion needs to be observed in detail, and the thickness d is made large in a portion where the active mass of the tissue is small because the portion is less important so as to display the peripheral tissue as much as possible and provide an image in which the positional relationship with the peripheral tissue is easily understood. Thus, image display responsive to the nature of the tissue to be observed is available.

In the image processing method of the invention, the generated surface is a flat plane. In the image processing method of the invention, the generated surface includes a plurality of continuous planes. In the image processing method of the invention the generated surface is a curved plane.

In the image processing method of the invention, the image processing is performed by network distributed processing. In the image processing method of the invention, the image processing is performed by a GPU (graphic processing unit). In the image processing method of the invention, the display data is used for a medical image.

A computer readable medium of the invention is a computer readable medium having a program including instructions for permitting a computer to perform an image processing for generating display data using a volume rendering method, said instructions comprising: generating a surface, which is cut out from volume data, as a surface to be displayed;

determining a thickness corresponding to each point on the generated surface based on at least one voxel value corresponding to said each point on the generated surface; and generating the display data corresponding to said each point on the generated surface based on at least one voxel value corresponding to the determined thickness.

### BRIEF DESCRIPTION OF THE DRAWINGS

FIGS. 1A and 1B show a thickness of a cross-section to cut out volume data in the present invention in comparison with that in a related art to describe an outline of an image processing method of the invention.

FIG. 2 is a flowchart to show the whole flow in the image processing method of an embodiment of the invention.

FIGS. 3A and 3B are drawings showing a method of determining the thickness d for each point P(x,y) using a look-up table (LUT) in the image processing method of an embodiment of the invention.

FIG. 4 is a flowchart of the method of determining the thickness d for each point P(x,y) using the LUT in the image processing method of an embodiment of the invention.

FIG. 5 is a drawing showing a method of determining the thickness d for each point P using neighborhood values of the point P in the image processing method of an embodiment of the invention.

FIG. 6 is a flowchart of the method of determining the thickness d for each point P using the neighborhood values of the point P in the image processing method of an embodiment of the invention.

FIG. 7 is a drawing showing a method (1) of determining the thickness d for each point P0 by an iterative determination in the image processing method of an embodiment of the invention.

FIG. 8 is a flowchart of the method (1) of determining the thickness d for each point P0 by the iterative determination in the image processing method of an embodiment of the invention.

FIG. 9 is a drawing showing a method (2) of determining the thickness d for each point P0 by an iterative determination in the image processing method of an embodiment of the invention.

FIG. 10 is a flowchart of the method (2) of determining the thickness d for each point P0 by the iterative determination in the image processing method of an embodiment of the invention.

FIG. 11 is a drawing showing a method (3) of determining the thickness d for each point P by an iterative determination in the image processing method of an embodiment of the invention.

FIG. 12 is a flowchart of the method (3) of determining the thickness d for each point P by the iterative determination in the image processing method of an embodiment of the invention.

FIGS. 13A and 13B are drawings showing a method of determining the thickness d for each point using external data corresponding to the point in the image processing method of an embodiment of the invention.

FIG. 14 is a flowchart of the method of determining the thickness d for each point using the external data corresponding to the point in the image processing method of an embodiment of the invention.

FIGS. 15A to 15D are explanatory drawings of setting directions of the thickness with respect to the arbitrary surface 11 in the image processing method of an embodiment of the invention.

FIGS. 16A and 16B are explanatory diagrams showing the case when an arbitrary cross-section is cut out from volume data by MPR (Multi Planar Reconstruction) for display.

FIGS. 17A and 17B show an example of displaying a cross-sectional curved surface along an arbitrary shape of a volume by CPR (Curved MPR).

FIG. 18A is a drawing showing an MPR image cut out on a plane (thickness 0).

FIG. 18B is a drawing showing an MIP image cut out on a plane having some thickness.

### DESCRIPTION OF THE PRFERRED EMBODIMENTS

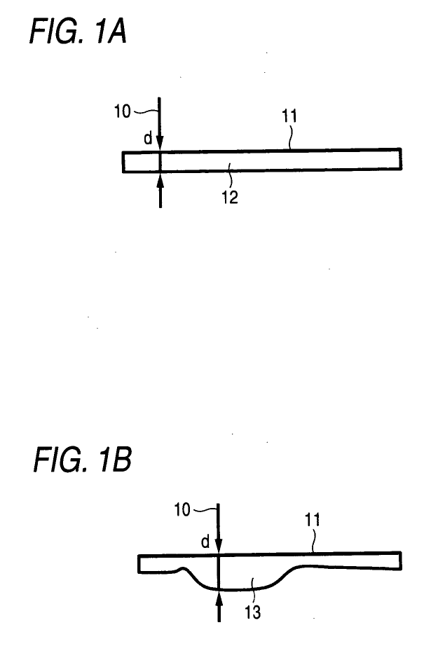

FIGS. 1A and 1B show a thickness of a cross-section to cut out volume data in the present invention in comparison with that in a related art to describe an outline of an image processing method of the invention. As shown in FIG. 1A, in MPR in the related art, in order to display an image of an arbitrary surface 11 with respect to a virtual ray 10, the volume data of a region 12 having a certain thickness d with the arbitrary surface 11 as its surface are referenced. Then, the average value of the volume data on the virtual ray, for example, is used as display data.

On the other hand, in the image processing method according to an embodiment of the invention, as shown in FIG. 1B, in order to display an image of the arbitrary surface 11 with respect to the virtual ray 10, the volume data of a region 13 having a non-uniform thickness d with the arbitrary surface 11 as its surface are referenced. Then, the average value of the volume data, for example, is used as display data. Here, when x-y coordinates are set on the arbitrary surface 11, the thickness d becomes a function of the coordinates (x, y) of each point on the arbitrary surface 11. In the embodiment, the arbitrary surface 11 is not limited to a flat plane (as in MPR), and can also be applied to a curved plane as in CPR, etc.

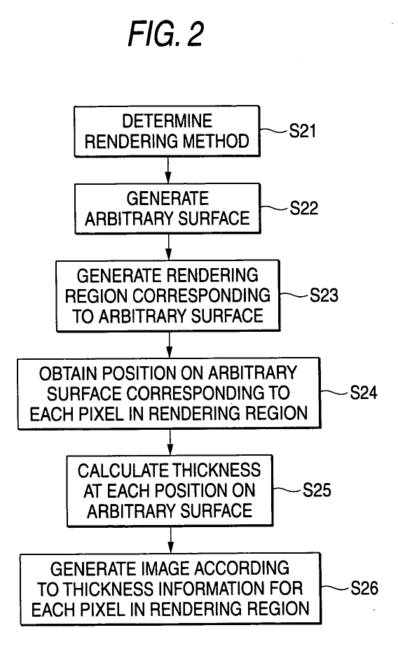

FIG. 2 is a flowchart to show the whole flow in the image processing method of the embodiment. In the image processing method of the embodiment, at first, a rendering method such as an average value method, a raysum method, a ray casting method, a MIP (Maximum Intensity Projection) method and a MinIP (Minimum Intensity Projection) method, is determined for the volume data containing the region 13 having the thickness of an observation object (see FIG. 1B) (step S21). Then, the arbitrary surface 11, which is a surface to be displayed, is generated (step S22).

Next, a rendering region corresponding to the arbitrary surface 11 is generated (step S23). This region or a region provided by further adding a correction to the rendering region becomes a region to be displayed as an image. A position (for example, x-y coordinate) on the arbitrary surface 11 corresponding to each pixel in the rendering region is obtained (step S24).

Next, the thickness d at the position (x,y) on the arbitrary surface 11 is calculated (step S25). A calculation method of the thickness d is described later in detail with reference to the accompanying drawings. An image is generated according to the thickness information for each pixel in the rendering region (step S26).

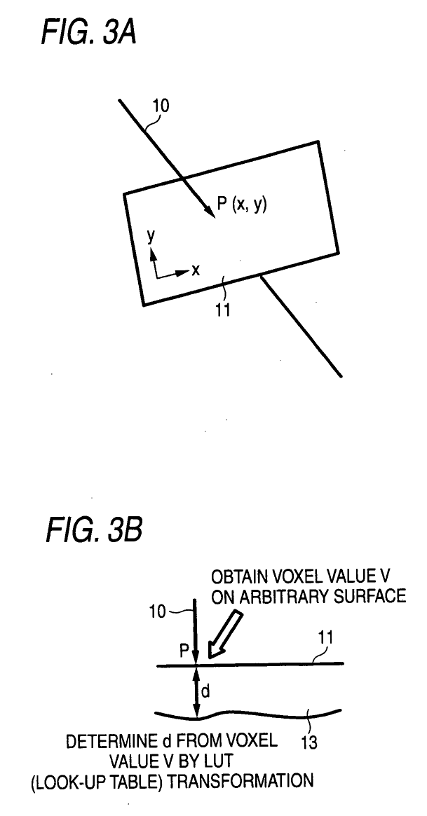

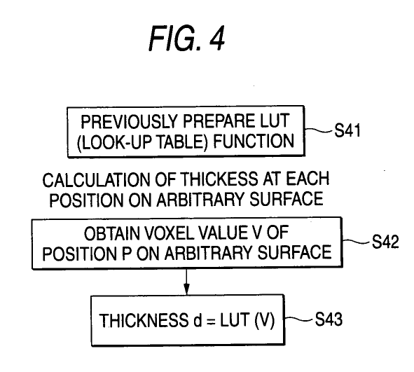

FIGS. 3A and 3B show a method of determining the thickness d for each point P(x,y) using a look-up table (LUT) in the image processing method of the embodiment. FIG. 4 is a flowchart of the method of determining the thickness d for each point P(x,y) using the LUT.

In the method, an LUT function is previously prepared (step S41) as shown in FIG. 4. When the thickness d is made to be related to a CT value which is the voxel value (pixel value of volume data) provided by a CT apparatus, for example, the LUT function is prepared by making a relationship as follows according to an observation object or an observation purpose: for example, a small thickness d for the CT value of a bone which is to be observed in detail and includes little noise; a large thickness d for the CT value of air which is not the observation object; a large thickness d for the CT value of a contrast medium to be removed as noise; and a small thickness d for the CT value of a muscle to be observed in detail.

Next, in order to calculate the thickness d at the point P(x,y) on the arbitrary surface 11, a voxel value V (CT value, in the case of a CT apparatus) of the point P(x,y) on the arbitrary surface 11 is obtained (step S42). Thickness d=LUT (V) is determined by executing an LUT transformation from the voxel value V of the point P (x, y) on the arbitrary surface 11 (step S43). LUT is a transformation function, and thus any other function may be used. Moreover, the thickness d can be dynamically changed by the user, by making LUT a function of a parameter that can be set by the user.

Thus, according to the image processing method of the embodiment, the thickness suitable for the tissue to be observed can be set with LUT, and the optimum thickness can be automatically determined for each position on the cross-section to be cut out. Therefore, noise can be reduced and the fine details of the tissue can also be displayed.

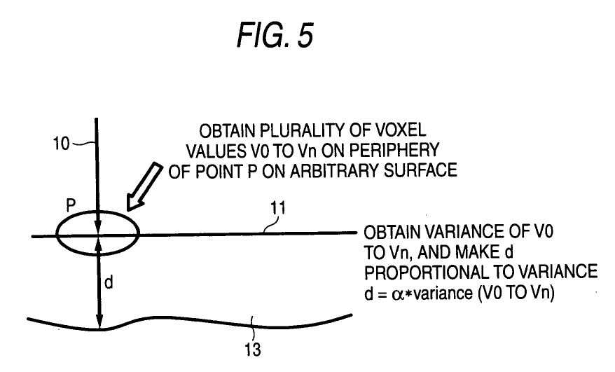

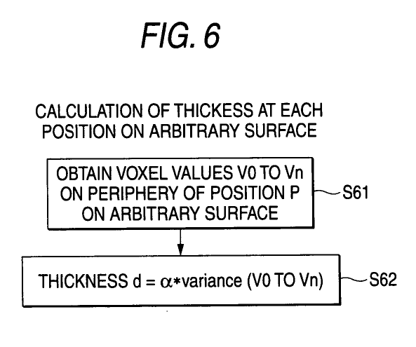

FIG. 5 shows a method of determining the thickness d for each point P(x,y) using neighborhood values of the point P(x,y) in the image processing method of the embodiment. FIG. 6 is a flowchart of the method of determining the thickness d for each point P(x,y) using the neighborhood values of the point P(x,y).

In the method, as shown in FIG. 6, in order to calculate the thickness d at each point P (x, y) on the arbitrary surface 11, a plurality of voxel values V0 to Vn on the periphery of the point P(x,y) on the arbitrary surface 11 are obtained (step S61). In this case, the plurality of voxel values V0 to Vn may be those in a lateral direction (direction along the arbitrary surface 11) or may be those in a depth direction (direction along the virtual ray 10), etc.

Next, for example, variance of the plurality of voxel values V0 to Vn is obtained, and the thickness d is made proportional to the variance (step S62). That is, thickness d=α*variance (V0 to Vn). The thickness d may be obtained not only with the variance, but also with any other function having a plurality of values as arguments, or may be obtained by calculating a logarithm of the values obtained by such function.

Thus, according to the image processing method of the embodiment, the thickness is set based on the information on the neighborhood tissue of the observation point, so that S/N can be improved and the fine details of the tissue can also be displayed clearly.

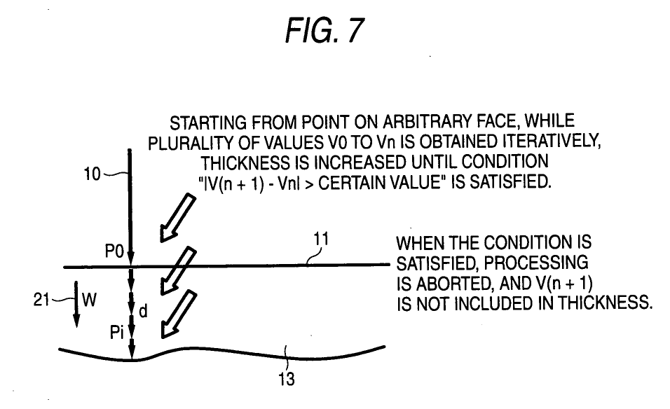

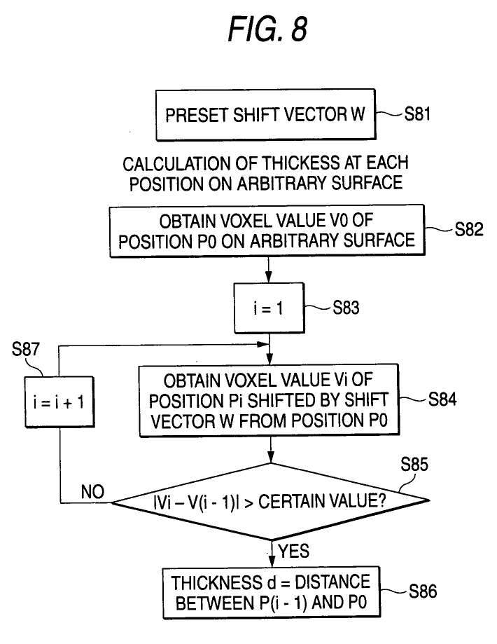

FIG. 7 shows a method (1) of determining the thickness d for each point P0(x,y) by an iterative determination in the image processing method of the embodiment. FIG. 8 is a flowchart of the method (1) of determining the thickness d for each point P0(x,y) by the iterative determination.

In the method, as shown in FIG. 7, a shift vector W 21 is preset in parallel with the virtual ray 10 (step S81), for example, and the thickness d at the point P0(x,y) on the arbitrary surface 11 is calculated. First, the voxel value V0 of the position P0(x,y) on the arbitrary surface 11 is obtained (step S82).

Next, a variable i is set to an initial value (i=1) (step S83), and the voxel value Vi of a position Pi (x, y) shifted by the shift vector W from the position P0(x, y) is obtained (step S84). Then, whether or not a difference between the voxel value Vi and the preceding voxel value V(i−1) is greater than a certain value (|Vi−V(i−1)|>certain value) is determined (step S85). If the difference between the voxel value Vi and the preceding voxel value V(i−1) is not greater than the certain value (NO), the variable i is incremented by one (i=i+1) (step S87), and the step S84 and the later steps are repeated.

On the other hand, if the difference between the voxel value Vi and the preceding voxel value V(i−1) is greater than the certain value (YES), a distance between P(i−1) and P0 is adopted as the thickness d corresponding to the point P0(x,y) (step S86).

Thus, in the embodiment, starting from the point P0(x,y) on the arbitrary surface 11, while a plurality of voxel values V0 to Vn is obtained iteratively, the thickness d is increased until the condition “|V(n+1)−V(n)|>certain value” is satisfied. When the condition is satisfied, the processing is aborted, and the voxel value V(n+1) is not included in the thickness d to be obtained. That is, rendering is performed using the thickness (V0 to Vn) rather than the thickness (V0 to V(n+1)). Through this processing, a boundary region of a tissue is detected, and a region which comes in front of the boundary region when looked in the direction of the virtual ray 10 is not rendered. Accordingly, different thickness can be set for each position on the arbitrary surface so as to reduce noise, and so that only the tissue of the observation object can be displayed while excluding other tissues in the proximity of the arbitrary surface.

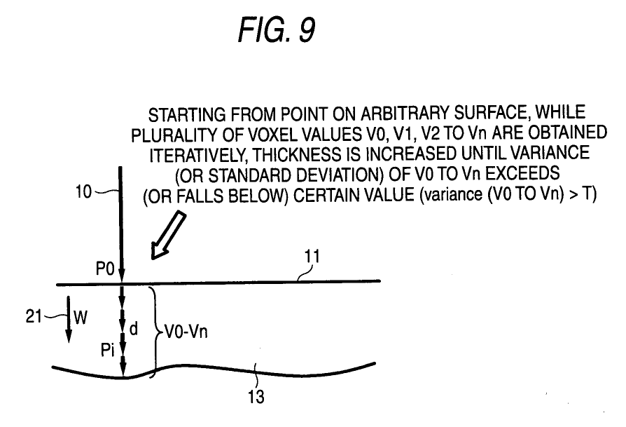

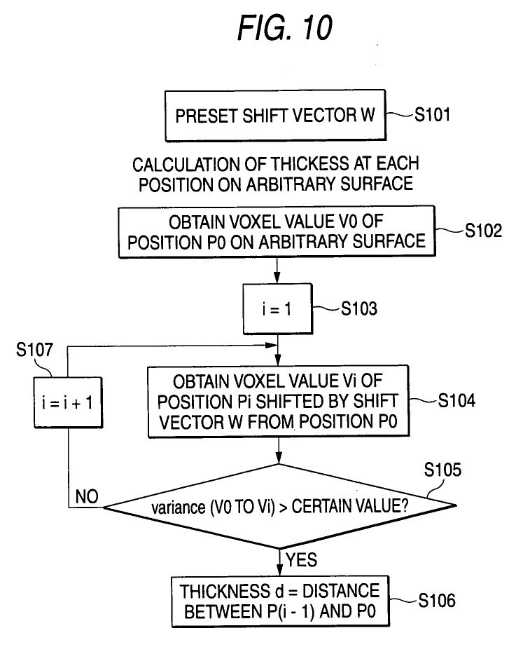

FIG. 9 shows a method (2) of determining the thickness d for each point P0 (x, y) by an iterative determination in the image processing method of the embodiment. FIG. 10 is a flowchart of the method (2) of determining the thickness d for each point P0(x,y) by the iterative determination.

In the method, as shown in FIG. 9, a shift vector W 21 is preset in parallel with the virtual ray 10 (step S101), for example, and the thickness d at the position P0(x,y) on the arbitrary surface 11 is calculated. First, the voxel value V0 of the position P0(x,y) on the arbitrary surface is obtained (step S102).

Next, a variable i is set to an initial value (i=1) (step S103), and the voxel value Vi of a position Pi (x, y) shifted by the shift vector W from the position P0 (x, y) is obtained (step S104). Then, whether or not a variance of the voxel values V0 to Vi is greater than a certain value (variance (V0 to Vi)>certain value) is determined (step S105). If the variance of the voxel values V0 to Vi is not greater than the certain value (NO), the variable i is incremented by one (i=i+1) (step S107), and the step S104 and the later steps are repeated.

On the other hand, if the variance of the voxel values V0 to Vi is greater than the certain value (YES), the distance between P(i−1) and P0 is adopted as the thickness d corresponding to the point P0(x,y) (step S106).

Thus, in the embodiment, starting from the point on the arbitrary surface, while a plurality of voxel values V0, V1, V2 to Vn are obtained iteratively, the thickness d is increased until the variance (or standard deviation) of the voxel values V0 to Vn exceeds (or falls below) the certain value. Accordingly, different thickness d can be set for each position on the cross-section to be cut out so as to reduce noise, and so that only the tissue of the observation object can be displayed by differentiating the front and the back of the boundary of the tissue. The method can also be generalized such that voxel values V0 to Vn are examined iteratively until a predetermined function g(V0 to Vn) satisfies a certain condition.

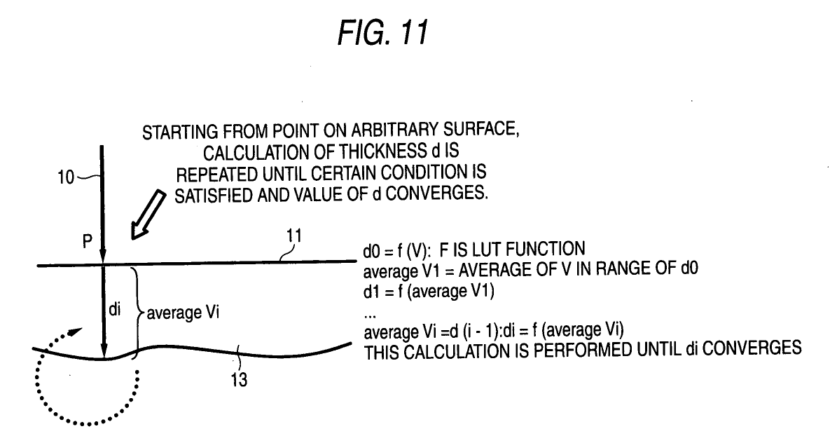

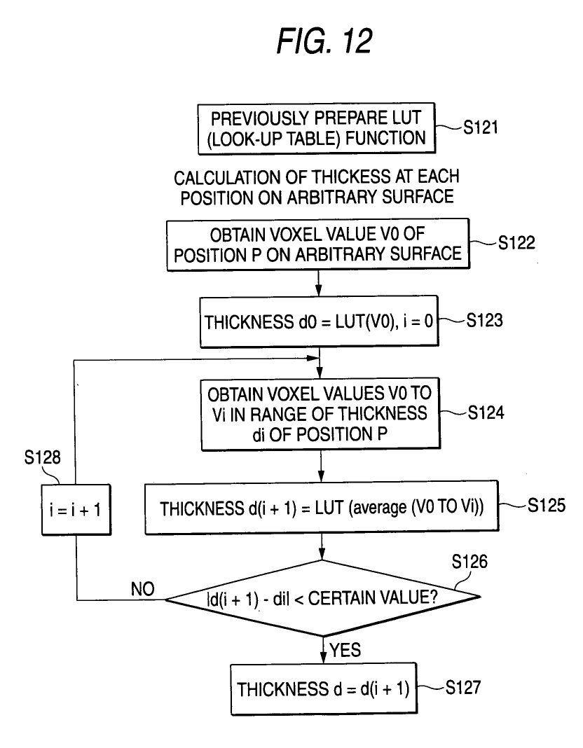

FIG. 11 shows a method (3) of determining the thickness d for each point P (x, y) by an iterative determination in the image processing method of the embodiment. FIG. 12 is a flowchart of the method (3) of determining the thickness d for each point P (x, y) by the iterative determination.

In the method, similarly as the case in FIG. 3, an LUT function is previously prepared based on the CT value provided by a CT apparatus (step S121), for example, and the thickness d at the position P(x,y) on the arbitrary surface is calculated. First, the voxel value V0 of the position P(x,y) on the arbitrary surface is obtained (step S122), and the thickness d0 corresponding to the voxel value V0 is obtained from the LUT. That is, thickness d0=LUT(V0), i=0 (step S123).

Next, voxel values V0 to Vi in a range of thickness di of the position P(x,y) are obtained (step S124), and thickness d(i+1) corresponding to, for example, the average value of the voxel values V0 to Vi is obtained from the LUT. That is, thickness d(i+1)=LUT(average(V0 to Vi)) (step S125).

Next, whether or not the difference between the thickness d(i+1) and thickness di is smaller than a certain value (|d(i+1)−di|<certain value) is determined (step S126). If the difference between the thickness d(i+1) and the thickness di is not smaller than the certain value (NO), the variable i is incremented by one (i=i+1) (step S128), and the step S124 and the later steps are repeated.

On the other hand, if the difference between the thickness d (i+1) and the thickness di is smaller than the certain value (YES), the calculation is determined to be converged, and the thickness d=d(i+1) corresponding to the point P(x,y) is determined (step S127).

Thus, in the embodiment, starting from the point on the arbitrary surface, the calculation is repeated until the certain condition is satisfied and the value of thickness d converges. Accordingly, different thickness can be set for each position on the cross-section to be cut out so as to reduce noise, and so that the thickness d can be determined more accurately with the LUT.

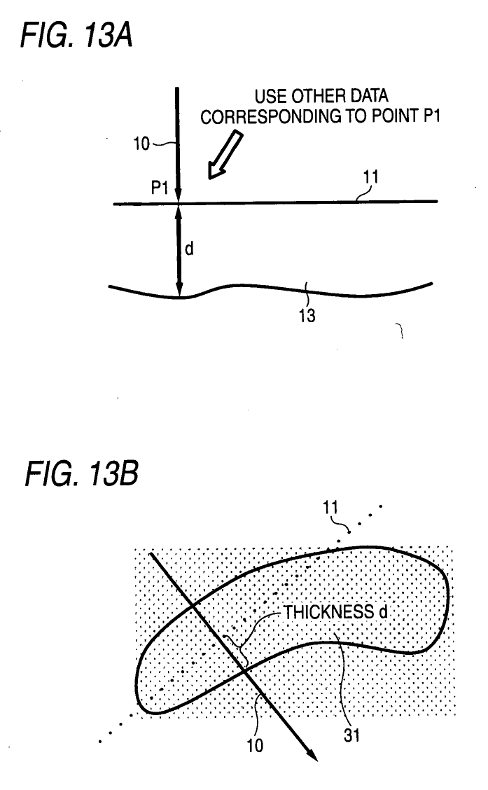

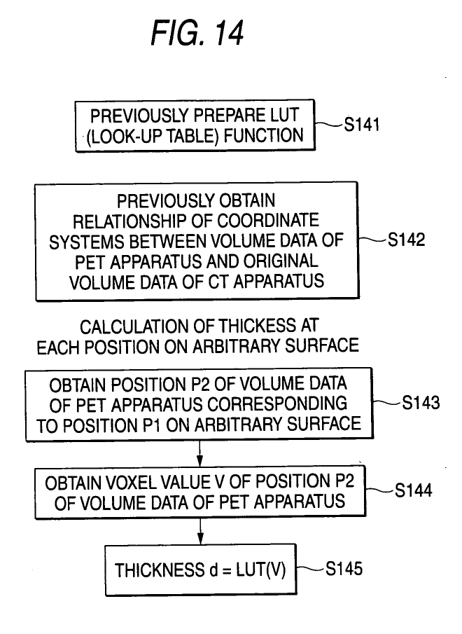

FIG. 13A shows a method of determining the thickness d for each point P1(x,y) using external data corresponding to the point P1(x,y) in the image processing method of the embodiment. FIG. 14 is a flowchart of the method of determining the thickness d for each point P1(x, y) using the external data corresponding to the point P1(x,y).

In the method, for example, using additional volume data provided by positron emission tomography (hereinafter, referred to as PET apparatus), an LUT function indicating the correspondence between the voxel value and the thickness is previously prepared (step S141). Then, a relationship of the coordinate systems between the volume data of the PET apparatus and the original volume data provided by the CT apparatus are previously obtained (step S142). This is because as the PET apparatus and the CT apparatus are different apparatuses, and delicately differ in patient postures at photographing time and the coordinate systems of the apparatuses, it is necessary to obtain the relationship of the coordinate systems when the data obtained by the PET apparatus and the CT apparatus are used in combination. Then, the thickness d at the position P1(x,y) on the arbitrary surface 11 in the volume data of the CT apparatus is calculated.

First, position P2(x,y) of the volume data of the PET apparatus corresponding to the position P1(x,y) on the arbitrary surface 11 in the volume data of the CT apparatus is obtained (step S143). Then, the voxel value V of the position P2(x,y) in the volume data of the PET apparatus is obtained (step S144). Next, thickness d=LUT (V) is obtained according to the LUT prepared with the volume data of the PET apparatus (step S145).

Thus, in the embodiment, for example, the thickness d is determined using the value of the data acquired from an apparatus other than the CT apparatus, such as the PET apparatus. From the PET apparatus, information which can not be provided by the CT apparatus, for example, an active mass of a tissue can be obtained. Thus, according to the active mass of the tissue, image display responsive to the nature of the tissue to be observed is possible as follows, for example: the thickness d of a portion where the active mass of the tissue is large is made small because the portion needs to be observed in detail, and the thickness d of a portion where the active mass of the tissue is small is made large because the portion need not be observed in detail and it is more desirable that the portion is displayed together with peripheral tissues so that the positional relationship of the tissues can be easily understood.

On the other hand, the thickness can also be determined using some other data obtained by calculation. For example, in “perfusion image,” a perfusion parameters are calculated based on each image along the time series. In the calculation itself, change in a plurality of voxel values of the images along the time series is analyzed by deconvolution. Usually, three parameters of BF (bloodstream), BV (blood volume), and MTT (mean transition time) obtained by the deconvolution are referred to as “perfusion parameters,” and the thickness can also be determined using the perfusion parameters.

As shown in FIG. 13B, the thickness d can also be determined using whether or not each point is included in a mask area 31 or using only the portion included in the mask area 31.

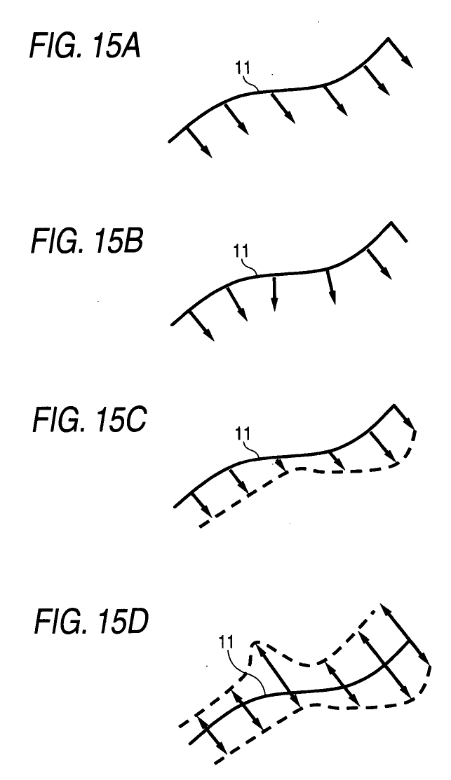

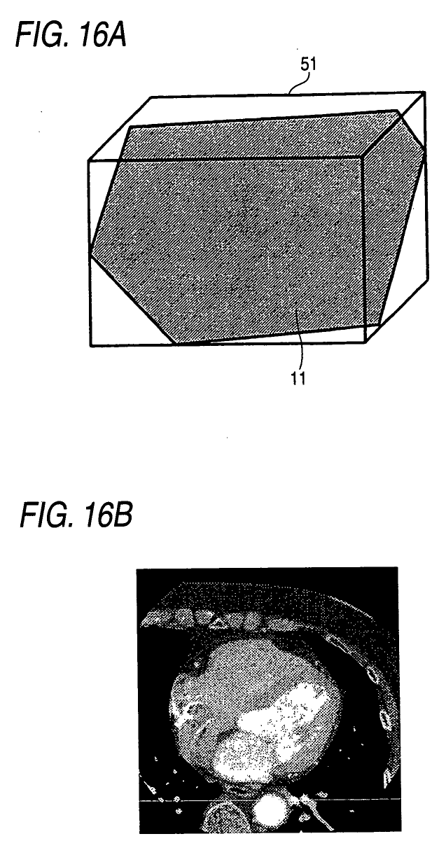

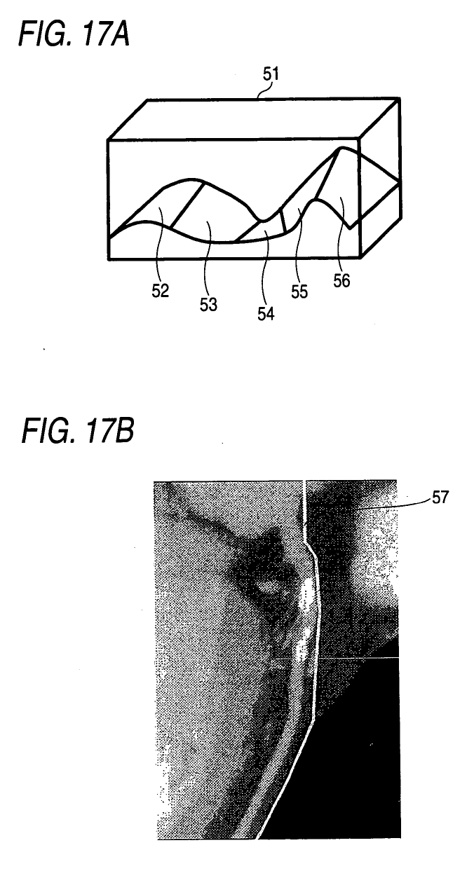

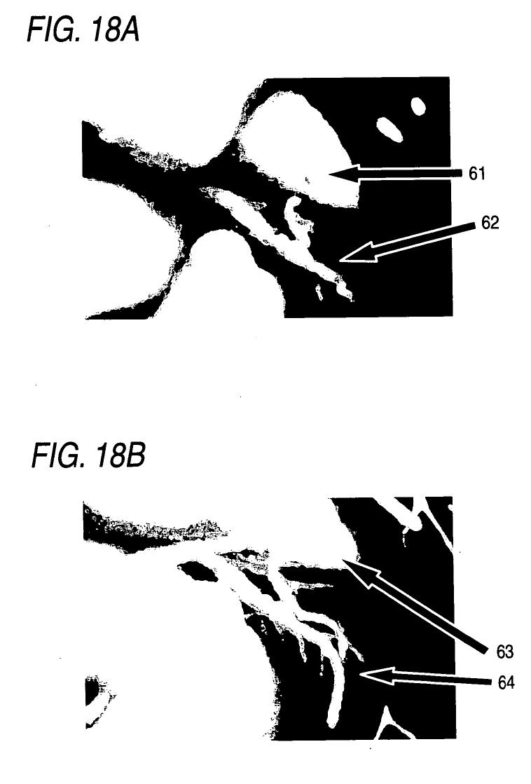

FIGS. 15A to 15D are explanatory drawings of the setting directions of the thickness d with respect to the arbitrary surface 11. The thickness d set with respect to each point of the arbitrary surface 11 may be set in a constant direction (FIG. 15A), may be set in the perpendicular direction to the arbitrary surface 11 (FIG. 15B), or may be set in any other direction. Furthermore, it may be extended to one side (FIG. 15C) or may be extended to both sides (FIG. 15D), etc. In extending the thickness d to both sides, it may be extended asymmetrically. When different tissues exist on both sides of the arbitrary surface 11, an understandable image can be displayed by making the thickness d of one side and the thickness d of the other side different from each other.

In the image processing method of the embodiment, the volume data is provided by a CT apparatus, but volume data may be provided from any other sources. For example, the volume data may be provided by an MRI (magnetic resonance imaging) apparatus or a PET apparatus. The volume data may be volume data modified by filtering or image analysis processing. The volume data may be volume data obtained by a calculation of numeric simulation, or may be a combination thereof.

In the image processing method of the embodiment, an implementation of the arbitrary surface is not limited. For example, the arbitrary surface may be a surface defined by a polygon, a surface configured with a plurality of polygons, a spline curved surface, an NURBS (non uniform rational B-spline) curved surface, or a curved surface defined by a function of a mathematical expression. The arbitrary surface may be a combination thereof.

The image processing method of the embodiment can be performed by a GPU (Graphic Processing Unit). GPU is an arithmetic processing unit particularly designed to be specialized in image processing in comparison with a general CPU. Usually, GPU is installed separately from the CPU.

In the image processing method of the embodiment, calculation of volume rendering can be divided in a certain rendering region, a region of a volume, etc., and can be later combined. Thus, the calculation can be performed by parallel processing, network distributed processing, a dedicated processor, or a combination thereof.

According to the image processing method and the computer readable medium for image processing of the invention, the thickness suitable for the observation object is determined, and the display data corresponding to each point on the arbitrary surface is generated from the plurality of voxel values corresponding to the thickness. Therefore, noise can be reduced and the fine details of the tissue can also be displayed clearly.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended-claims and their equivalents.

What is claimed is:

1. An image processing method for generating display data using a volume rendering method, said image processing method comprising:
generating a surface;
determining a thickness corresponding to each point on the generated surface based on at least one voxel value corresponding to said each point on the generated surface; and
generating the display data corresponding to said each point on the generated surface, based on at least one voxel value corresponding to the determined thickness.

2. The image processing method as claimed in claim 1, wherein the display data is calculated by at least any one of a raysum method, an average value method and a ray casting method.

3. The image processing method as claimed in claim 1, wherein the display data is calculated by an MIP (Maximum Intensity Projection) method or a MinIP (Minimum Intensity Projection) method.

4. The image processing method as claimed in claim 1, wherein the thickness is determined based on the voxel value of at least one point in the proximity of said each point on the generated surface.

5. The image processing method as claimed in claim 1, wherein the thickness is changed dynamically.

6. The image processing method as claimed in claim 1, wherein the thickness is determined with reference to an LUT (look-up table) indicating relations between the voxel value and the thickness.

7. The image processing method as claimed in claim 1, wherein the thickness is determined with reference to external data corresponding to said each point on the generated surface.

8. The image processing method as claimed in claim 1, wherein the generated surface is a flat plane.

9. The image processing method as claimed in claim 1, wherein the generated surface includes a plurality of continuous planes.

10. The image processing method as claimed in claim 1, wherein the generated surface is a curved plane.

11. The image processing method as claimed in claim 1, wherein the image processing is performed by network distributed processing.

12. The image processing method as claimed in claim 1, wherein the image processing is performed by a GPU (graphic processing unit).

13. The image processing method as claimed in claim 1, wherein the display data is used for a medical image.

14. A computer readable medium having a program including instructions for permitting a computer to perform an image processing for generating display data using a volume rendering method, said instructions comprising:
generating a surface;
determining a thickness corresponding to each point on the generated surface based on at least one voxel value corresponding to said each point on the generated surface; and
generating the display data corresponding to said each point on the generated surface based on at least one voxel value corresponding to the determined .thickness.
